(19) United States
(12) Patent Application Publication
(10) Pub. No.: US 2004/0255194 A1
(43) Pub. Date: Dec. 16, 2004

(54) Testing computer applications

(75) Inventors: Michael B. Genkin, North York (CA); Michael Starkey, Vancouver (CA)

Correspondence Address: John D. Flynn, IBM Corporation, Dept. T81/Bldg. 503, PO Box 12195, Research Triangle Park, NC, 27709, US

(73) Assignee: International Business Machines Corporation, Armonk, NY (US)

(21) Appl. No.: 10/768,827

(22) Filed: Jan. 30, 2004

(30) Foreign Application Priority Data
May 27, 2003 (CA) 2,429,876

(51) Int. Cl. H02H 3/05

(52) U.S. Cl. 714/28

(57) ABSTRACT

An emulating system is provided for testing a computer application for use with a target computing system. The emulating system emulates the input/output behavior of the target system. The emulating system has access to a data source, which contains a plurality of requests acceptable to the target system and a plurality of responses. Each acceptable request is associated with a response that describes the expected behavior of the target system in response to the acceptable request. After communication between the emulating system and the application is established, the emulating system responds to a request from the application by obtaining a response associated with the request from the data source and responding as described by the response associated with the request.

### PRIORITY BENEFIT AND CROSS REFERENCE TO RELATED APPLICATIONS

This Application claims priority under 35 U.S.C. §119(a) to Canadian Patent Application No. 2429876 filed May 27, 2003, which is hereby incorporated herein by reference in its entirety.

### TECHNICAL FIELD

The present invention relates to testing computer applications, and more particularly to testing a target computing system with an emulating system that emulates the input/output behavior of the target system.

### BACKGROUND INFORMATION

A computer application needs to be tested, for example, to either verify or demonstrate its performance, on a target computing system. A target computing system is a computing system for which the application is to be used.

To test an application on a target system, both the application and the target system need to be configured to work with each other. Particularly, critical components on the target system may need to be reconfigured properly. A critical component is a component of the target system that provides information or services to the application during testing. Reconfiguring a target system may require stoppage of its operation. To avoid interruption of service, it is common practice to set up a duplicate system with identical critical components for the purpose of testing applications. For example, to test an application for an Enterprise Information System (EIS), the duplicate system needs to have the same EIS installed and configured to work with the application. Setting up a large and complex system or critical component, such as an EIS, can be quite involved, expensive, and time consuming. Sometimes, it is even impractical to set up a duplicate system. For instance, it may not be feasible for a salesperson to set up an EIS at a remote site just to demonstrate a new application to a potential client.

In addition, configuring a complex system to test a new application may require extensive knowledge and experience in both application development and system operation including the operation of critical components. The process can be difficult to manage, because few users have sufficient knowledge/experience in both fields and it may require the coordination and cooperation of a number of application developers and system operators, often from different units of a company or even different companies.

Thus, there is a need for a simple, convenient, and inexpensive way to test computer applications.

### SUMMARY

An application for use with a target computing system is tested with an emulating system, which emulates the input/output behavior of the target system. The emulating system responds to each request received from the application according to a previously generated response that describes the expected behavior of the target system.

In accordance with an embodiment of the present invention, there is provided a method of testing a computer application for use with a target computing system, which comprises establishing communication between the application and an emulating system. The emulating system responds to a request from the application by (a) obtaining a response associated with the request from a data source, the data source containing a plurality of requests acceptable to the target computing system and a plurality of responses, each acceptable request being associated with a response that describes the expected behavior of the target computing system in response to the acceptable request; and (b) responding as described by the response associated with the request.

The data source may comprise one or more files. The emulating system may comprise an emulator adapted to receive the request from the application, obtain the response associated with the request from the data source, and respond to the application as described by the response associated with the request.

In accordance with another embodiment of the present invention, there is provided a computing system which is adapted to carry out the method just described.

In accordance with yet another embodiment of the present invention, there is provided an article of manufacture which comprises a computer readable medium storing computer executable code for emulating a target computer system which when executed by a processor in a computer, causes said computer to (a) receive a request; (b) obtain a response associated with the request from a data source, the data source containing a plurality of requests acceptable to the target computing system and a plurality of responses, each acceptable request being associated with a response that describes the expected behavior of the target computing system upon receiving the acceptable request; and (c) respond as described by the response associated with the request.

In accordance with still another embodiment of the present invention, there is provided a method of emulating a target computing system, which comprises (a) receiving a request; (b) obtaining a response associated with the request from a data source, the data source containing a plurality of requests acceptable to the target computing system and a plurality of responses, each acceptable request being associated with a response that describes the expected behavior of the target computing system upon receiving the acceptable request; and (c) responding as described by the response associated with the request.

In accordance with yet another embodiment of the present invention, there is provided an article of manufacture comprising a computer readable medium storing computer executable code which when executed by a computer causes the computer to undertake the method described in the last paragraph.

In accordance with still another embodiment of the present invention, there is provided a computing system which is adapted to carry out the method described in the second last paragraph.

Advantageously, not all of the critical components need to be installed, or, if already installed, reconfigured, on the emulating system for testing the application. Further, it is easy to manage the set-up and configuration process. Thus, setting up and configuring the emulating system can be convenient, quick and inexpensive.

Other aspects, features and advantages of the present invention will become apparent to those of ordinary skill in the art upon review of the following description of specific embodiments of the present invention in conjunction with the accompanying figures.

### BRIEF DESCRIPTION OF THE DRAWINGS

A better understanding of the present invention can be obtained when the following detailed description is considered in conjunction with the following drawings, in which:

FIG. 1 is a block diagram illustrating the testing of a computer application in accordance with an embodiment of the present invention;

FIG. 2 is a block diagram illustrating an exemplary embodiment of the emulating system of FIG. 1;

FIG. 3 is a schematic diagram illustrating an exemplary embodiment of the multiple data sources of a computer with an emulator installed on the computer; and

FIG. 4 is a flowchart diagram illustrating the logic of operation of the emulating system of FIG. 2 in accordance with an embodiment of the present invention.

### DETAILED DESCRIPTION

As used herein, the following terms have the following meanings:

“Request”, as a noun, means a communication received from a computer application by a computing system.

“Response”, as a noun, means a communication to a computer application from a computing system.

“Communication” means any transmission of information. For example, information can be transmitted by data, action, and inaction.

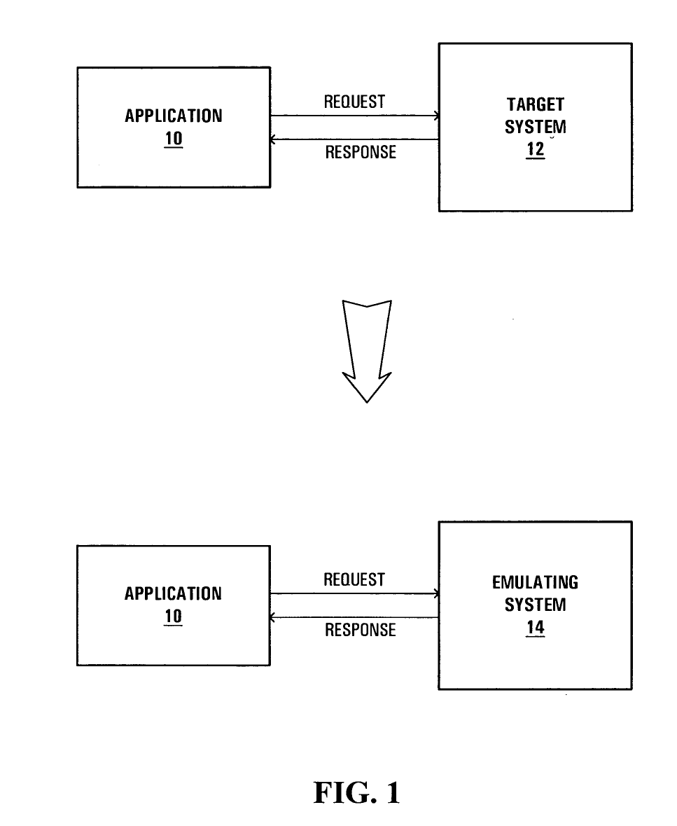

Referring to FIG. 1, a computer application 10 developed for use with a target computing system 12 is tested with an emulating system 14 that emulates the input/output behavior of target system 12. Emulating system 14 responds to requests received from application 10 in the same way as target system 12 does. However, the responses are not generated in real-time after receiving each request. Rather, the responses are pre-generated and stored as data. Thus, no critical components need to be set up or reconfigured on emulating system 14 such that many difficulties associated with setting up or configuring these critical components can be avoided.

Application 10 can be any application that can communicate with target system 12. In use, application 10 may be executed on the target system 12, or on another computing system in communication with target system 12. Application 10 may also communicate with other applications or systems. For example, application 10 may be a mid-tier application, which interfaces between a server application on target system 12 and a client application running on another computing system. In such a case, depending on the purpose of testing, the target system 12 may comprise a computer running the server application and another computer running the mid-tier application, or the target system 12 may comprise only one of the two computers.

A computing system may be a standalone computer (such as a desktop, a laptop, or a workstation), a server, a computing network, or the like. A target computing system 12 is a computing system for which application 10 is to be used. For example, target system 12 may comprise an EIS, such as a Customer Information Control System (CICS), IMS™, SAP™, PeopleSoft™, and the like, from or to which application 10 may request or provide information.

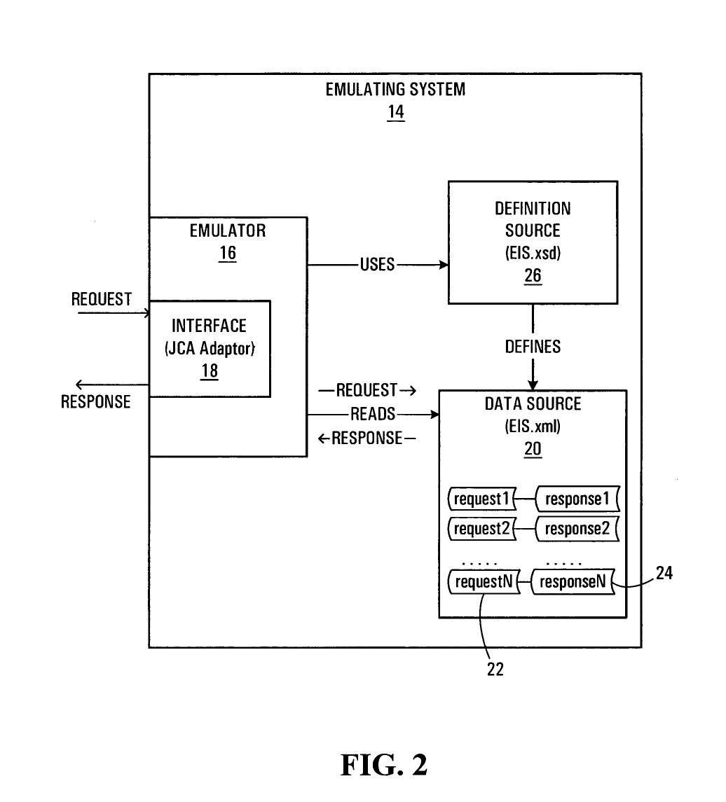

FIG. 2 illustrates an exemplary embodiment of emulating system 14 in accordance with an embodiment of the present invention, which emulates an EIS accessible through a Java™ server. Emulating system 14 comprises an emulator 16 which has an interface 18 for communicating with application 10 (FIG. 1). Emulator 16 has access to a data source 20. Data Source 20 contains a plurality of requests 22 acceptable to target system 12. Data source 20 also contains a plurality of responses 24, each of which describes how target system 12 will respond to a certain request 22. Each acceptable request 22 is associated with a response 24 that describes the expected behavior of target system 12 in response to that particular request. Emulator 16 may also have access to a definition source 26, which defines the format of data source 20. The use and benefit of definition source 26 will be described below.

Emulator 16 can be implemented in any computer programming language and can be either a standalone program or a component of a program suite.

Interface 18 can be implemented in any suitable manner. An interface compliant with a commonly accepted standard may be preferable because the same interface can be used to work with different types of applications and systems. In the exemplary embodiment illustrated in FIG. 2, interface 18 comprise a JCA-compliant resource adapter, which can be deployed to any Java™ 2 Enterprise Edition (J2EE) server and work with various components on the server, such as Java Beans™, Enterprise JavaBeans™ (EJB), and various Java™ Services.

Emulator 16 and interface 18 are not described in detail herein as a skilled person in the art would know how they could be implemented.

Data source 20 may include any information that is necessary or desirable for describing and associating the requests 22 and responses 24 stored therein.

Requests 22 and responses 24 can be any requests or responses target system 12 may receive or send. For example, requests and responses may relate to connections, users, operations, data, transactions, security, and the like.

The content of data source 20 can be generated manually or automatically. For example, actual operations of target system 12 may be recorded and used as entries in data source 20. Depending on the purpose of testing, as well as the time and resources available, the content of data source 20 may be comprehensive or limited to a particularly aspect of the system. A data source may be created specifically for a particular application or generally for a class of applications.

Data source 20 can be stored in any suitable computer readable form. For instance, data source 20 can be one or more files containing textual data stored on a computer readable medium. In the exemplary embodiment illustrated in FIG. 2, data source 20 comprises a single Extended Markup Language (XML) file named EIS.xml, where the format of the file conforms to an XML schema. While other types of files or forms of data storage can also work, a single text file with a standard format has certain benefits. One of the benefits is that it is easy to create and maintain the file.

Optionally, the format of the data source 20 may be defined in a definition source 26, which may comprise one or more files, such as a Data Type Definition (DTD) file. In the exemplary embodiment illustrated in FIG. 2, definition source 26 comprises a single XML Schema Definition file, EIS.xsd.

As can be appreciated, emulating system 14 can be easily modified to emulate any other computing system, with or without a Java server.

The program code for emulator 16 may be distributed or stored in any suitable way. For example, emulator 16 can be stored in a single Java jar file containing the adapter deployment descriptor and adapter code.

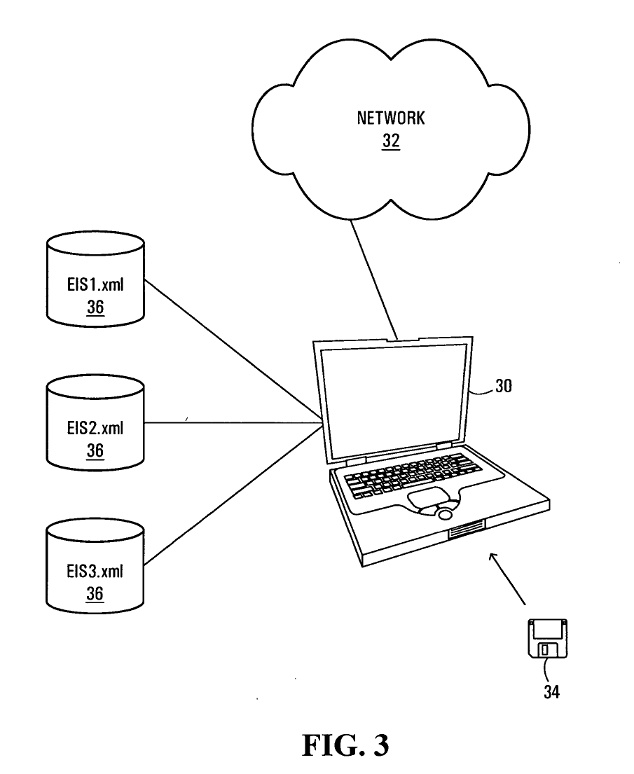

Referring to FIG. 3, emulator 16 may be installed on a computer 30, which can be a portable, a desktop, or any other type of computer. Computer 30 has a processor, a memory and other components such as a central processing unit, secondary storage, input/output devices, networking devices, and the like. Computer 30 may be connected to a network 32 and have access to computer readable medium 34 and 36. Emulator 16 can be stored on any computer readable medium accessible by computer 30, such as memory, disk, or any other electronic storage, e.g, computer readable medium 34.

Emulator 16 needs to be able to communicate with application 10, which may be running on either computer 30 or another computer connected to computer 30 through network 32, and has access to data source 20, and optionally definition source 26. If desired or required, emulator 16 may communicate or interact with other components of computer 30 or other applications and servers running on network 32. However, emulator 16 can be coded to have no external dependencies on any of the critical components, whereas such external dependencies would have been necessary if application 10 were tested with target system 12. For example, it is not necessary that a database or a search engine is installed and running on computer 30, even though application 10 may make requests to them.

Similar to emulator 16, data source 20 and definition source 26 may be stored in any memory or other computer readable medium accessible to computer 30. As illustrated in FIG. 3, computer 30, and thus emulator 16, may have access to multiple data sources 20 stored on computer readable media 36, such as files EIS1.xml, EIS2.xml and EIS3.xml, each of which contains request/responses for a different target system (EIS1, EIS2, and EIS3, respectively). The benefit of having multiple accessible data sources can be readily appreciated by a person skilled in the art and will become apparent from description below.

In operation, emulator 16 is deployed or activated on emulating system 14, such as computer 30. Application 10 can be executed on either emulating system 14 or a different computing system so long as application 10 and emulating system 14 can communicate with each other through emulator interface 18.

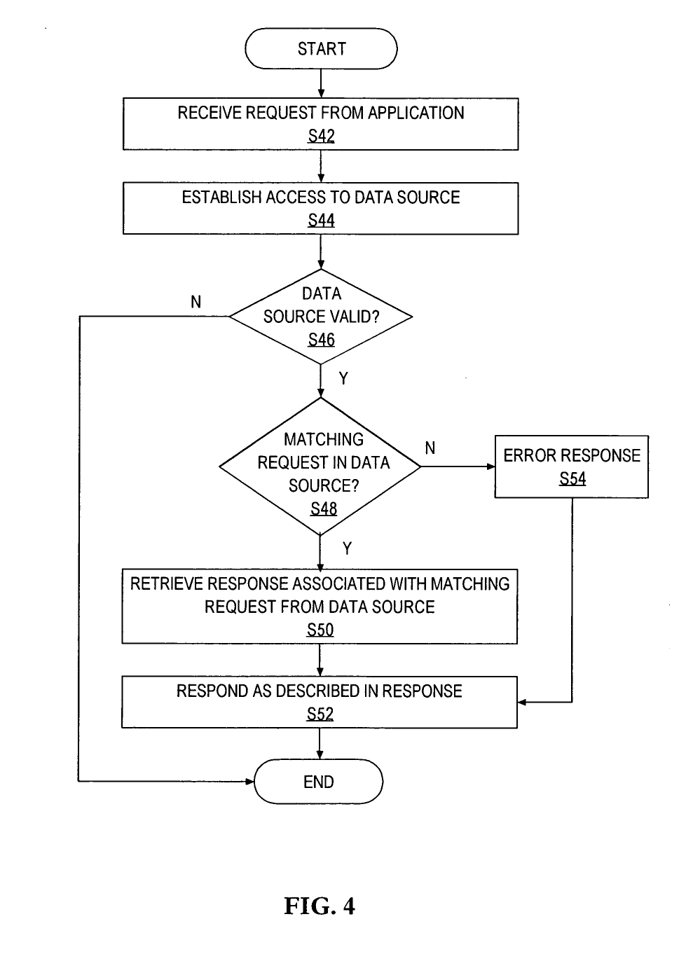

Referring to FIG. 4, emulator 16 may be invoked by receiving a request from application 10 (S42). To respond to a request, a data source 20 needs to be identified. Optionally, the request may include information on how to access data source 20, such as the name and location of a file. If so provided, emulator 16 may establish access to data source 20 accordingly (S44), such as opening the given file with read access. As can be appreciated, access to data source 20 may be established before any communication between application 10 and emulator 16, such as when multiple applications for a same target system are tested.

After identifying and establishing access to data source 20, the validity of data source 20, such as file EIS.xml, may be verified by parsing it and comparing it against the format definition stored in definition source 26 (S46), if a definition source is provided. Different data source files may be verified against a same definition source. For example, EIS1.xml, EIS2.xml, and EIS3.xml may all be verified against a single definition file, such as EIS.xsd.

If the format of data source 20 is not valid, emulator 16 may simply terminate communication with application 10. Alternatively, emulator 16 may report an error, ask for a new data source, or take some other appropriate action.

If the format of data source 20 is valid, emulator 16 arranges for searching data source 20 for a matching request 22 (S48). Two requests may match in a narrow or a broad sense. In some cases, the request received must be identical to a request 22 stored in data source 20 for there to be a match. For example, user names, passwords, commands, and function calls may have to match identically. In other cases, a class of requests received may match a request 22 stored in data source 20. For example, any legitimate user name may match a “username” request. Further, whether two requests match may be context-dependent. For example, an input text string may only “match” a password text string in a login procedure and only after a user name has been matched. For example, any string input may match a request 22 which provides a new file name to the target system 12.

If there is no match, emulator 16 may retrieve a default error response (S54) and respond accordingly (S52). For instance, emulator 16 may send an error message. Alternatively, the connection with application 10 may be terminated immediately.

If a match is found, emulator 16 arranges for retrieving the response 24 associated with the matching request 22 (S50) and responds to application 10 as described in the retrieved response 24 (S52).

As can be appreciated, it may be desirable to include in data source 20 those requests 22 and responses 24 that can be used to test key characteristics or aspects of application 10 or target system 12 or both. For example, key characteristics of target system 12 may include connection, transaction, security, and performance characteristics. To illustrate, some example requests and responses are described below.

An initial request is typically a connection request for establishing a connection between application 10 and emulator 16. If the associated response 24 provides that a connection should only be established after checking a connection limit (such as a limited number of users on the system), emulator 16 may check the connection limit and only establish the connection if the limit has not been exceeded. If the limit has been exceeded, emulator 16 may refuse to establish the connection.

Another typical request 22 is a user request, such as a request to log on to a server. As is typical, emulator 16 may respond by authenticating the user identity before complying with the user request.

Other typical requests include function calls, data queries, user commands, input and output messages, and the like. Corresponding responses 24 may include return values for function calls, data records from a database, input/output messages, and the like.

Inactivity for a certain period at a communication port can in itself be considered a request 22 or response 24, or part of a request 22 or response 24. For example, a response 24 may provide that an output message should be sent to application 10 after a certain time delay. This delay may be necessary, for example, to simulate an overloaded system or a situation in which it would take such a delay for the target system 10 to generate the output message. Similarly, inactivity on the application 10 side may also prompt a response or some action from emulator 16, such as prompting for input or terminating an idle connection.

Responses 24 can be context-sensitive. For example, an output message may incorporate part of an input message received earlier. For instance, an error message may indicate the nature of the error or which part of the request received caused the error, such as “invalid username” or “missing parameter X in function call Y”.

Depending on the situation, emulator 16 may also respond to a request 22 by taking certain action such as invoking a system operation. For example, emulator 16 may undertake an action as described by the associated response, collect a result of the action, and report the result to application 10.

Optionally, a default response 24 may be provided to describe how to respond when there is no other match in data source 20 for a request received.

It should be understood that in appropriate cases emulating system 14 may respond to some requests from application 10 without obtaining an associated response from data source 20, such as when the relevant critical component is installed and configured on the emulating system 14 so that it can generate the same response as the target system does.

As can be appreciated by a person skilled in the art, the use of data source 20 and definition source 26 is advantageous for many reasons. For instance, it is no longer necessary to set up and configure all of the critical components on the emulating system 14 for testing application 10. A single emulator 16 can be easily adapted for emulating many different target systems by accessing different data sources 20. Multiple applications for one or more target systems can be tested simultaneously or alternatively on a single emulating system such as computer 30 where emulator 16 can access multiple data sources, as illustrated in FIG. 3. The use of definition source 26 further facilitates the use of different data sources because format definitions need not be hard-coded into emulator 16 but can be dynamically loaded.

Setting up an emulating system 14 for testing an application 10 can be a simple and easy process which mainly comprises installing and configuring emulator 16 on a computer system and obtaining access to an appropriate data source 20, and optionally definition source 26. Since emulator 16 can be implemented as a relatively small software program, it is easy to distribute, store, and install.

Further, data source 20 and emulator 16 can be created, developed, and set up independently, at different places and times by different programmers and operators with different skills and experiences. Thus, management difficulties and overhead can be reduced.

For all of these and other reasons, the emulating system 14 can be set up and configured more easily, quickly, and conveniently than target system 12.

Emulating system 14 can be very useful for demonstration purposes or at early stages of application development such as in unit or component testing. In both cases, the requests 22 and responses 24 in data source 20 are limited and easy to generate.

Other features, benefits and advantages of the present invention not expressly mentioned above can be understood from this description and the accompanying drawings by those skilled in the art.

Although only a few exemplary embodiments of the present invention have been described above, those skilled in the art will readily appreciate that many modifications are possible therein without materially departing from the novel teachings and advantages of the present invention.

The present invention, rather, is intended to encompass all such modifications within its scope, as defined by the claims.

What is claimed is:

1. A method of testing a computer application for use with a target computing system, comprising:
establishing communication between said application and an emulating system, said emulating system responding to a request from said application by:
a. obtaining a response associated with said request from a data source, said data source containing a plurality of requests acceptable to said target computing system and a plurality of responses, each acceptable request being associated with a response that describes the expected behavior of said target computing system in response to said acceptable request; and
b. responding as described by said response associated with said request.

2. The method of claim 1, wherein said responding comprises undertaking an action as described by said response associated with said request, collecting a result of said action, and reporting said result to said application.

3. The method of claim 1, further comprising establishing access to said data source by said emulating system.

4. The method of claim 3, wherein said obtaining comprises searching said data source for a matching request and, upon finding said matching request, retrieving the response associated with said matching request.

5. The method of claim 1, wherein said emulating system comprises an emulator adapted to receive said request from said application, obtain said response associated with said request from said data source, and respond to said application as described by said response associated with said request.

6. The method of claim 5, wherein said emulator comprises an interface for communicating with said application.

7. The method of claim 4, wherein said data source comprises at least one file.

8. The method of claim 7, wherein said at least one file comprises a single file.

9. The method of claim 7, further comprising verifying the validity of said at least one file.

10. The method of claim 9, wherein said verifying comprises verifying that the format of said at least one file conforms to a standard format stored in a definition source.

11. The method of claim 10, wherein said at least one file conforms to an extended markup language (XML) schema.

12. The method of claim 11, wherein said definition source comprises a document type definition (DTD) file.

13. The method of claim 1, wherein said target computing system comprises an information system.

14. The method of claim 13, wherein said information system is an enterprise information system.

15. An article of manufacture comprising:
a computer program product embodied in a machine readable medium for emulating a target computer system comprising the programming steps of:
a. receiving a request;
b. obtaining a response associated with said request from a data source, said data source containing a plurality of requests acceptable to said target computing system and a plurality of responses, each acceptable request being associated with a response that describes the expected behavior of said target computing system upon receiving said acceptable request; and
c. responding as described by said response associated with said request.

16. The article of claim 15, wherein said programming step of responding comprises the programming steps of:
undertaking an action as described by said response associated with said request;
collecting a result of said action; and
reporting said result to said application.

17. The article of claim 15, wherein said programming step of obtaining a response comprises the programming steps of:
searching said data source for a matching request; and
retrieving the response associated with said matching request upon finding said matching request.

18. The article of claim 15, wherein said data source comprises at least one file.

19. The article of claim 18, wherein said at least one file comprises a single file.

20. The article of claim 18, wherein said computer program product further comprises the programming step of:
verifying the validity of said at least one file.

21. The article of claim 20, wherein the format of said at least one file is verified as being conforming to a format definition stored in a definition source.

22. The article of claim 21, wherein said definition source comprises a document type definition (DTD) file.

23. The article of claim 21, wherein said at least one file conforms to an extended markup language (XML) schema.

24. The article of claim 15, wherein said target computing system comprises an information system.

25. The article of claim 24, wherein said information system is an enterprise information system.

26. A method of emulating a target computing system, comprising:
a. receiving a request;
b. obtaining a response associated with said request from a data source, said data source containing a plurality of requests acceptable to said target computing system and a plurality of responses, each acceptable request being associated with a response that describes the expected behavior of said target computing system upon receiving said acceptable request; and
c. responding as described by said response associated with said request.

27. A system, comprising:
a memory unit operable for storing a computer program for testing a computer application for use with a target computing system; and
a processor coupled to said memory unit, wherein said processor, responsive to said computer program, comprises:
circuitry operable for receiving a request from said application;
circuitry operable for obtaining a response associated with said request from a data source, said data source containing a plurality of requests acceptable to said target computing system and a plurality of responses, each acceptable request being associated with a response that describes the expected behavior of said target computing system in response to said acceptable request; and
circuitry operable for responding as described by said response associated with said request.

28. The system as recited in claim 27, wherein said circuitry operable for responding comprises:
circuitry operable for undertaking an action as described by said response associated with said request;
circuitry operable for collecting a result of said action; and
circuitry operable for reporting said result to said application.

29. The system as recited in claim 27, wherein said circuitry operable for obtaining comprises:
circuitry operable for searching said data source for a matching request; and
circuitry operable for retrieving the response associated with said matching request upon finding said matching request.

30. The system as recited in claim 27, wherein said data source comprises at least one file, wherein said processor further comprises:
circuitry operable for verifying the validity of said at least one file

31. The system as recited in claim 30, wherein said circuitry operable for verifying comprises:
circuitry operable for verifying that the format of said at least one file conforms to a standard format stored in a definition source.

32. The system as recited in claim 31, wherein said at least one file conforms to an extended markup language (XML) schema.

33. The system as recite in claim 32, wherein said definition source comprises a document type definition (DTD) file.

34. A system, comprising:
a memory unit operable for storing a computer program for emulating a target computing system computer; and
a processor coupled to said memory unit, wherein said processor, responsive to said computer program, comprises:
circuitry operable for receiving a request;
circuitry operable for obtaining a response associated with said request from a data source, said data source containing a plurality of requests acceptable to said target computing system and a plurality of responses, each acceptable request being associated with a response that describes the expected behavior of said target computing system upon receiving said acceptable request; and
circuitry operable for responding as described by said response associated with said request.
